(19) United States
(12) Patent Application Publication
(10) Pub. No.: US 2026/0321958 A1
(43) Pub. Date: Oct. 15, 2026

(54) MOUNTING ASSEMBLY FOR AN ANTENNA

(71) Applicant: OUTDOOR WIRELESS NETWORKS LLC, Richardson, TX (US)

(72) Inventors: Karthik KONDAVEETI, Andhra Pradesh (IN); Ravi Kiran Reddy TADIPARTHI, Andhra Pradesh (IN); Chaitanya MODAK, Chiplun (IN); Veera Venkata Naga Raju JONNALAGADDA, Andhra Pradesh (IN)

(21) Appl. No.: 19/116,579

(22) PCT Filed: Sep. 1, 2023
(86) PCT No.: PCT/US2023/073269

§ 371 Date: Mar. 28, 2025

Related U.S. Application Data
(60) Provisional application No. 63/379,310, filed on Oct. 13, 2022.

(51) Int. Cl. H01Q 1/12; F16B 2/06

(52) U.S. Cl. CPC H01Q 1/1264; F16B 2/06

(57) ABSTRACT

A mounting assembly for an antenna includes a first bracket coupled to a rear surface of the antenna and a second bracket connected to a gripping clamp. The first bracket comprises two side walls, such that each side wall of the two side walls is defined having a longitudinal slot and a plurality of first indexing holes. The second bracket comprises a center hole and a plurality of second indexing holes. The center hole is configured to align with longitudinal slot of the first bracket and at least two second indexing holes of plurality of second indexing holes aligned with corresponding first indexing holes of the plurality of first indexing holes of the first bracket, to facilitate mounting of the antenna.

### RELATED APPLICATION

The present application claims priority from and the benefit of U.S. Provisional Patent Application No. 63/379,310, filed Oct. 13, 2022, the disclosure of which is hereby incorporated herein by reference in full.

### TECHNICAL FIELD

disclosure relates to communication systems and, in particular, to a mounting assembly for a base station antenna.

### BACKGROUND

The information in this section merely provides background information related to the present disclosure and may not constitute prior art(s) for the present disclosure.

Cellular communications systems are used to provide wireless communications to fixed and mobile subscribers (herein “users”). A cellular communications system may include a plurality of base stations that each provide wireless cellular service for a specified coverage area that is typically referred to as a “cell”. Each base station may include one or more base station antennas that are used to transmit radio frequency (“RF”) signals to, and receive RF signals from, the users that are within the cell served by the base station. Base station antennas are directional devices that can concentrate the RF energy that is transmitted in certain directions (or received from those directions). The selection of a cellular base station antenna is a critical consideration in an efficient cellular network, particularly choosing the antenna with suitable physical characteristics for a specific application.

Typical base station antennas have large size and are bulky and heavy; therefore, such antennas typically require two or more mounting assemblies for mounting the base station antenna on a support structure, for example, a pole. The multiple mounting brackets are generally employed to provide support to the large and heavy base station antennas. The multiple mounting brackets generally include support brackets and tilt adjustment brackets. The multiple mounting brackets are connected at different locations on the base station antennas. Furthermore, each mounting bracket connected to the base station antenna provides one dedicated function; for example, one or more brackets may be mounted at different lengths of the base station antenna provide only support to the base station antenna and an additional bracket is required to provide tilting operation of the base station antenna. Also, the operation for adjusting tilt angle of the base station antennas may be difficult and time-consuming.

In addition to the electronic steering of the antenna beam, base station antennas may be mechanically steered vertically in an elevation plane. Mechanical tilt to the base station antenna may be used to reduce interference and/or to modify coverage in a specific area and to concentrate coverage in a designated area. In a typical installation, the antenna is mounted to a support structure, such as a pole, by at least a pair of brackets. The mechanical tilt of the antenna is typically performed by pivoting the antenna about a horizontal axis defined by a first bracket using a second adjustable bracket mounted at a different location along the length of the base station antenna. One typical adjustable bracket comprises a scissor-style bracket. The scissor-style bracket is generally mounted near a top end cap of the base station antennas and is configured to provide tilt angle adjustment to base station antennas. However, the scissor-style bracket does not provide sufficient strength to the heavy base station antennas and therefore, there is a requirement for mounting one or more additional brackets near a bottom end cap of the base station antennas, which in turn increases the overall cost of the base station antennas. Further, the scissor-style bracket has more fixing or pivoting points to facilitate tilting of the base station antenna.

More recently, mounting assemblies of the base station antenna include different kind of mounting brackets or supporting brackets to provide support to the base station antenna of varying length. The mounting brackets are further connected to one or more intermediate brackets configured to facilitate tilting movement of the base station antenna. In general, the intermediate brackets are defined as scissor-style bracket (as described above). Manufacturers have sought, proposed, and implemented different solutions to address the problems associated with intermediate brackets, for example scissor-style brackets. One of the existing solutions includes utilizing an intermediate bracket or clamp connected to a mounting bracket of the base station antenna, to govern tilting movement of the base station antenna. The intermediate bracket comprises a plurality of holes defined on a side wall of the intermediate flange. The plurality of holes is configured to hold the base station antenna at predefined tilt angles. However, utilization of the intermediate bracket does not provide functionality to adjust the base station antenna at any tilt angle. Also, the utilization of the intermediate bracket increases number of components in the assembly of the base station antenna, which in turn increases overall cost of the base station antenna assembly. The presence of multiple intermediate components in base station antenna assembly may also have high impact on antenna PIM.

Accordingly, there remains a need of a mounting assembly for base station antennas that addresses at least the problems identified above and provides less impact on antenna PIM and reduces overall cost of the mounting assembly of the base station antenna.

### SUMMARY

The one or more shortcomings of the prior art are overcome by the assembly as claimed, and additional advantages are provided through the provision of the assembly as claimed in the present disclosure. Additional features and advantages are realized through the techniques of the present disclosure. Other embodiments and aspects of the disclosure are described in detail herein and are considered a part of the claimed disclosure.

Pursuant to the embodiments of the present disclosure, in an aspect, a mounting assembly for a base station antenna is provided. The mounting assembly comprises a first bracket adapted to be coupled to a rear surface of the antenna and a second bracket connected to a gripping clamp. The first bracket is adjustably connected to the second bracket to adjust a tilt angle of the antenna. The first bracket comprises two side walls, such that each side wall of the two side walls is defined having a longitudinal slot and a plurality of first indexing holes. The second bracket comprises a center hole and a plurality of second indexing holes. The center hole is configured to align with the longitudinal slot of the first bracket and at least two second indexing holes of the plurality of second indexing holes are aligned with corresponding first indexing holes of the plurality of first indexing holes of the first bracket, to facilitate mounting of the antenna.

In another non-limiting embodiment of the present disclosure, the second bracket is integrally formed with the gripping clamp.

In another non-limiting embodiment of the present disclosure, the plurality of first indexing holes in the first bracket are defined circumscribing the longitudinal slot defined in each side wall of the two side walls of the first bracket.

In another non-limiting embodiment of the present disclosure, the second bracket comprises two lateral flanges, such that each lateral flange of the two lateral flanges is defined having the center hole and the plurality of second indexing holes.

In another non-limiting embodiment of the present disclosure, the mounting assembly comprises a pair of fasteners, such that one fastener is allowed to pass through the longitudinal slot defined in one side wall of the first bracket and the center hole defined in one flange of the second bracket. Another fastener is allowed to pass through the longitudinal slot defined in another side wall of the first bracket and the center hole defined in another flange of the second bracket.

In another non-limiting embodiment of the present disclosure, the mounting assembly comprises a lock nut received on a threaded portion of each fastener of the pair of fasteners.

In another non-limiting embodiment of the present disclosure, the mounting assembly further comprises at least one locking pin adapted to be received in the first indexing holes of the first bracket and the second indexing holes of the second bracket, to secure the antenna at the tilt angle.

In another non-limiting embodiment of the present disclosure, the second bracket is configured to grip a support structure for mounting the antenna.

In another non-limiting embodiment of the present disclosure, the first bracket comprises a first end and a second end. The first end connected to the antenna is positioned below the second end connected to the second bracket.

In another aspect of the present disclosure, a mounting assembly for an antenna is disclosed. The mounting assembly includes a first bracket adapted to be coupled to a rear surface of the antenna and a second bracket configured to grip a support structure for mounting the antenna. The first bracket is adjustably connected to the second bracket to adjust a tilt angle of the antenna. The first bracket comprises two side walls, such that each side wall of the two side walls is defined having a longitudinal slot in shape of an arc and a plurality of first indexing holes. The second bracket comprises a center hole and a plurality of second indexing holes. The center hole is configured to align with the longitudinal slot of the first bracket and at least two second indexing holes of the plurality of second indexing holes are aligned with corresponding indexing holes of the plurality of first indexing holes of the first bracket, to facilitate mounting of the antenna.

In another non-limiting embodiment of the present disclosure, the second bracket comprises two lateral flanges extending integrally from a base plate of the second bracket, such that each lateral flange of the two lateral flanges is defined having the center hole and the plurality of second indexing holes.

In another non-limiting embodiment of the present disclosure, the second bracket comprises two longitudinal flanges extending integrally from the base plate, each longitudinal flange of the two longitudinal flanges is defined having serrations to grip the second bracket with the support structure.

In another non-limiting embodiment of the present disclosure, each side wall of the two side walls of the first bracket is defined in shape of an arc that is complimentary to the arc of the longitudinal slot defined in the side wall.

In another non-limiting embodiment of the present disclosure, the first bracket comprises a first end and a second end. The first end connected to the antenna is positioned below the second end connected to the second bracket.

In another aspect of the present disclosure, a mounting assembly for an antenna is disclosed. The mounting assembly includes a first bracket adapted to be coupled to a rear surface of the antenna and a second bracket connected to a gripping clamp. The first bracket is adjustably connected to the second bracket to adjust a tilt angle of the antenna. The first bracket comprises two side walls, such that each side wall of the two side walls is defined having a longitudinal slot and a plurality of first indexing holes. The first bracket comprises a first end and a second end, such that the first end connected to the rear surface of the antenna and the second end connected to the second bracket are aligned along a mounting axis (X-X) of the antenna. The second bracket comprises a center hole and a plurality of second indexing holes, such that the center hole is configured to align with the longitudinal slot of the first bracket and at least two second indexing holes of the plurality of second indexing holes are aligned with corresponding first indexing holes of the plurality of first indexing holes of the first bracket, to facilitate mounting of the antenna.

In another non-limiting embodiment of the present disclosure, the second bracket is removably connected to a gripping clamp by fasteners, and the gripping clamp is configured to grip a support structure for mounting the antenna.

In another non-limiting embodiment of the present disclosure, the plurality of first indexing holes in the first bracket are defined circumscribing the longitudinal slot defined in each side wall of the two side walls of the first bracket.

In another aspect of the present disclosure, a mounting assembly for an antenna is disclosed. The mounting assembly includes a first bracket adapted to be coupled to a rear surface of the antenna and a first bracket adapted to be coupled to a rear surface of the antenna. The first bracket is adjustably connected to the second bracket to adjust a tilt angle of the antenna. The first bracket comprises two side walls, such that each side wall of the two side walls is defined having a longitudinal slot and a plurality of first indexing holes. The first bracket comprises a first end and a second end, such that the first end connected to the rear surface of the antenna is positioned below the second end connected to the second bracket. The second bracket comprises a center hole and a plurality of second indexing holes. The center hole is configured to align with the longitudinal slot of the first bracket and at least two second indexing holes of the plurality of second indexing holes are aligned with corresponding first indexing holes of the plurality of first indexing holes of the first bracket, to facilitate mounting of the antenna.

In another non-limiting embodiment of the present disclosure, the second bracket comprises two longitudinal flanges and two lateral flanges extending integrally from the base plate. The two lateral flanges extend from the base plate of the second bracket in a direction opposite to a direction of the two longitudinal flanges.

In another non-limiting embodiment of the present disclosure, the plurality of first indexing holes in the first bracket are defined circumscribing the longitudinal slot defined in each side wall of the two side walls of the first bracket.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 is a perspective view of a mounting assembly for mounting a base station antenna to a support structure, for example, a pole, at a maximum tilt angle, in accordance with an embodiment of the present disclosure;

FIG. 2 is a side view of the mounting assembly of FIG. 1 at zero tilt angle, in accordance with an embodiment of the present disclosure;

FIG. 3 is a perspective detailed view of the mounting assembly of FIG. 1, in accordance with an embodiment of the present disclosure;

FIG. 4 is a side view of the mounting assembly of FIG. 2, in accordance with an embodiment of the present disclosure;

FIG. 5 is a perspective view of a first bracket of the mounting assembly of FIG. 1, in accordance with an embodiment of the present disclosure;

FIG. 6 is a perspective view of a second bracket of the mounting assembly of FIG. 1, in accordance with an embodiment of the present disclosure;

FIG. 7 is a perspective view of a mounting assembly for mounting a base station antenna to a support structure, for example, a pole, at maximum tilt angle, in accordance with another embodiment of the present disclosure;

FIG. 8 is a perspective view of the mounting assembly of FIG. 7 at zero tilt angle, in accordance with another embodiment of the present disclosure;

FIG. 9 is a perspective detailed view of the mounting assembly of FIG. 7, in accordance with an embodiment of the present disclosure;

FIG. 10 is an enlarged view of a portion A of a first bracket of the mounting assembly of FIG. 9, in accordance with an embodiment of the present disclosure;

FIG. 11 is a perspective view of the first bracket of FIG. 9, in accordance with an embodiment of the present disclosure;

FIG. 12 is a perspective view of a second bracket of the mounting assembly of FIG. 7, in accordance with another embodiment of the present disclosure;

FIG. 13 is a perspective view of the first bracket of the mounting assembly of FIG. 8, in accordance with an embodiment of the present disclosure;

FIG. 14 is a side view of the first bracket of FIG. 13, in accordance with an embodiment of the present disclosure;

FIG. 15 is a perspective view of a mounting assembly for mounting a base station antenna to a support structure, for example, a pole, at maximum tilt angle, in accordance with yet another embodiment of the present disclosure;

FIG. 16 is a perspective view of the mounting assembly of FIG. 15 at zero tilt angle, in accordance with yet another embodiment of the present disclosure;

FIG. 17 is a perspective detailed view of the mounting assembly of FIG. 15, in accordance with yet another embodiment of the present disclosure;

FIG. 18 is an enlarged view of a portion B of a first bracket of the mounting assembly of FIG. 17, in accordance with yet another embodiment of the present disclosure;

FIG. 19 is a perspective view of the first bracket of FIG. 18, in accordance with yet another embodiment of the present disclosure;

FIG. 20 is a perspective view of a second bracket of the mounting assembly of FIG. 15, in accordance with yet another embodiment of the present disclosure; and FIG. 21 is a side view of the mounting assembly of FIG. 16, in accordance with an embodiment of the present disclosure.

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present disclosure.

### DETAILED DESCRIPTION

While the disclosure is susceptible to various modifications and alternative forms, specific embodiments thereof have been shown by way of example in the FIGS. and will be described in detail below. It should be understood, however that it is not intended to limit the disclosure to the particular forms disclosed, but on the contrary, the disclosure is to cover all modifications, equivalents, and alternatives falling within the scope of the disclosure as defined by the appended claims.

Before describing detailed embodiments, it may be observed that the present disclosure is directed to a mounting assembly for an antenna. It is to be noted that a person skilled in the art can be motivated from the present disclosure and modify the various constructions of the mounting assembly of base station antenna. However, such modification should be construed within the scope of the present disclosure. Accordingly, the drawings are showing only those specific details that are pertinent to understanding the embodiments of the present disclosure so as not to obscure the disclosure with details that will be readily apparent to those of ordinary skill in the art having benefit of the description herein.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusions, such that a device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

The terms like “at least one” and “one or more” may be used interchangeably or in combination throughout the description.

Embodiments of the mounting assembly described in the present disclosure are configured to provide a mechanical tilt to adjust the base station antenna (hereinafter referred to as “antenna”) when compared to the existing systems, eliminates loose components, reduces the number of components that the installer needs to loosen, eliminates alignment issues and eliminates scissor pinch points. Furthermore, the antenna may utilize only one mounting assembly to for mounting the antenna of smaller length on the support structure. However, the mounting assembly may be modified to provide sufficient support and tilt angle adjustment to the antennas having varying physical parameters.

Pursuant to embodiments of the present disclosure, a mounting assembly for connecting an antenna to a support structure is disclosed. The antenna may be referred to as base station antenna configured to transmit radio frequency to a base station. The antenna is configured to be mounted to a support structure, for example—pole, mast and likewise. The mounting assembly is configured to mount the antenna onto the pole and to facilitate tilt adjustment of the antenna. The mounting assembly utilizes minimum number of components to govern tilt adjustment of the antenna and thereby reduces overall cost of the antenna, for example-manufacturing cost, assembling cost, transportation cost and like. In an exemplary embodiment, the mounting assembly utilizes less packaging space during transportation of the components from a manufacturing unit to a mounting site.

The mounting assembly includes a first bracket adapted to be coupled to a rear surface of the antenna and a second bracket connected to a gripping clamp. The first bracket is adjustably connected to the second bracket to adjust a tilt angle of the antenna. The first bracket comprises two side walls, such that each side wall of the two side walls is defined having a longitudinal slot and a plurality of first indexing holes. The second bracket comprises a center hole and a plurality of second indexing holes. The center hole is configured to align with the longitudinal slot of the first bracket and at least two second indexing holes of the plurality of second indexing holes are aligned with corresponding first indexing holes of the plurality of first indexing holes of the first bracket, to facilitate mounting of the antenna.

The first bracket may be defined having a rectangular structure, an arc shaped structure and likewise. The first bracket may also be defined as a combination of two plates comprising a longitudinal slot and a plurality of first indexing holes. In an exemplary embodiment, the first bracket is defined having an arc shaped structure. The first bracket is configured to be connected to the antenna by fasteners. The antenna may comprise a clamp fixed to a rear surface of the antenna and the first bracket is removably connected to the clamp to facilitate mounting of the first bracket with the antenna. Alternatively, or additionally, the first bracket may removably connected to the rear surface of the antenna by fasteners.

The mounting assembly may comprise an intermediate bracket movably connected to an intermediate portion of the antenna to provide support to the antenna. The intermediate bracket may be configured to be connected to the antenna, in situations when the antenna is having a longer length and therefore, the assembly requires extra bracket to provide support to the antenna. The intermediate bracket is connected to a pair of intermediate gripping clamps by means of fasteners and through the second bracket. In an exemplary embodiment, the second bracket and one intermediate gripping clamp of the pair of intermediate gripping clamps are integrally formed to have a unitary structure. Further, the mounting assembly may also include a pair of lower gripping clamps connected to a lower portion of the antenna to provide support to the longer length antenna and to secure the antenna in adverse climate conditions. The pair of gripping clamps, the pair of intermediate gripping clamps, and the pair of lower gripping clamps are positioned at equidistance from each other. Alternatively, or additionally, the position of the respective gripping clamps may vary depending on shape and size of the antenna.

The second bracket is configured to connect the first bracket with a gripping clamp of the mounting assembly. The gripping clamp is mounted on the support structure and is configured to grip the support structure for mounting the antenna. In an exemplary embodiment, a pair of gripping clamps are mounted on the support structure by fasteners. Each gripping clamp of the pair of gripping clamps is defined having a plurality of serrations on at least one surface of the gripping clamp. The plurality of serrations is configured to provide effective gripping on the support structure for mounting the antenna.

In an embodiment, the second bracket is integrally formed with the gripping clamp. The integral formation of the second bracket with the gripping clamp reduces inventory of the mounting assembly and thereby reduces overall cost of the mounting assembly. A unitary structure of the second bracket in accordance with the present embodiment, is configured to provide provisions for mounting the first bracket with the support structure and also provide effective gripping on the support structure.

In an embodiment, the second bracket comprises two lateral flanges, such that each lateral flange of the two lateral flanges is defined having the center hole and the plurality of second indexing holes.

In another non-limiting embodiment, the plurality of first indexing holes in the first bracket is defined circumscribing the longitudinal slot defined in each side wall of the two side walls of the first bracket. Alternatively, or additionally, the positioning of the plurality of first indexing holes may vary depending on shape of the first bracket. The longitudinal slot defined in each side wall of the first bracket is configured to facilitate adjustment of the tilt angle of the antenna. The plurality of first indexing holes is adapted to receive at least one locking pin to secure the antenna at a predefined tilt angle. The locking pin may be defined as a dowel pin, but not limited to the same. Alternatively, or additionally, a cylindrical structure may be utilized to be received in the plurality of first indexing holes to secure the antenna at the predefined tilt angle. The plurality of first indexing holes is configured to be aligned with at least one second indexing hole of the plurality of second indexing holes and then the at least one locking pin is configured to pass through the at least one second indexing hole aligned with the plurality of first indexing holes.

In accordance with further embodiments, the mounting assembly comprises a pair of fasteners, such that one fastener is allowed to pass through the longitudinal slot defined in one side wall of the first bracket and the center hole defined in one flange of the second bracket and another fastener is allowed to pass through the longitudinal slot defined in another side wall of the first bracket and the center hole defined in another flange of the second bracket.

In an embodiment, the mounting assembly comprises a lock nut received on a threaded portion of each fastener of the pair of fasteners. The lock nut is provided to prevent unintentional loosening of fasteners and thereby making the antenna secured with the support structure. Alternatively, or additionally, other locking mechanisms, for example locking pin and likewise may be utilized to prevent loosening of the fasteners.

In an embodiment, the mounting assembly further comprises at least one locking pin adapted to be received in the first indexing holes of the first bracket and the second indexing holes of the second bracket, to secure the antenna at the tilt angle.

In an embodiment, the first bracket comprises a first end and a second end. The first end connected to the antenna is positioned below the second end connected to the second bracket.

In another embodiment of the present disclosure, a mounting assembly for the antenna is disclosed. The mounting assembly includes a first bracket adapted to be coupled to a rear surface of the antenna and a second bracket configured to grip a support structure for mounting the antenna. The first bracket is adjustably connected to the second bracket to adjust a tilt angle of the antenna. The first bracket comprises two side walls, such that each side wall of the two side walls is defined having a longitudinal slot in shape of an arc and a plurality of first indexing holes. The second bracket comprises a center hole and a plurality of second indexing holes. The center hole is configured to align with the longitudinal slot of the first bracket and at least two second indexing holes of the plurality of second indexing holes are aligned with corresponding indexing holes of the plurality of first indexing holes of the first bracket, to facilitate mounting of the antenna.

The second bracket comprises two lateral flanges extending integrally from a base plate of the second bracket, such that each lateral flange of the two lateral flanges is defined having the center hole and the plurality of second indexing holes. The second bracket comprises two longitudinal flanges extending integrally from the base plate, each longitudinal flange of the two longitudinal flanges is defined having serrations to grip the second bracket with the support structure. Each side wall of the two side walls of the first bracket is defined in shape of an arc that is complimentary to the arc of the longitudinal slot defined in the side wall.

In an embodiment, a mounting assembly for the antenna is disclosed. The mounting assembly includes a first bracket adapted to be coupled to a rear surface of the antenna and a second bracket connected to a gripping clamp. The first bracket is adjustably connected to the second bracket to adjust a tilt angle of the antenna. The first bracket comprises two side walls, such that each side wall of the two side walls is defined having a longitudinal slot and a plurality of first indexing holes. The first bracket comprises a first end and a second end, such that the first end connected to the rear surface of the antenna and the second end connected to the second bracket are aligned along a mounting axis (X-X) of the antenna. The second bracket comprises a center hole and a plurality of second indexing holes, such that the center hole is configured to align with the longitudinal slot of the first bracket and at least two second indexing holes of the plurality of second indexing holes are aligned with corresponding first indexing holes of the plurality of first indexing holes of the first bracket, to facilitate mounting of the antenna.

The second bracket is removably connected to a gripping clamp by fasteners, and the gripping clamp is configured to grip a support structure for mounting the antenna. The plurality of first indexing holes in the first bracket is defined circumscribing the longitudinal slot defined in each side wall of the two side walls of the first bracket.

In another embodiment, a mounting assembly for an antenna is disclosed. The mounting assembly includes a first bracket adapted to be coupled to a rear surface of the antenna and a first bracket adapted to be coupled to a rear surface of the antenna. The first bracket is adjustably connected to the second bracket to adjust a tilt angle of the antenna. The first bracket comprises two side walls, such that each side wall of the two side walls is defined having a longitudinal slot and a plurality of first indexing holes. The first bracket comprises a first end and a second end, such that the first end connected to the rear surface of the antenna is positioned below the second end connected to the second bracket. The second bracket comprises a center hole and a plurality of second indexing holes. The center hole is configured to align with the longitudinal slot of the first bracket and at least two second indexing holes of the plurality of second indexing holes are aligned with corresponding first indexing holes of the plurality of first indexing holes of the first bracket, to facilitate mounting of the antenna. The second bracket comprises two longitudinal flanges and two lateral flanges extending integrally from the base plate. The two lateral flanges extend from the base plate of the second bracket in a direction opposite to a direction of the two longitudinal flanges. The plurality of first indexing holes in the first bracket is defined circumscribing the longitudinal slot defined in each side wall of the two side walls of the first bracket.

Reference will now be made to the exemplary embodiments of the disclosure, as illustrated in the accompanying drawings. Wherever possible same numerals will be used to refer to the same or like parts.

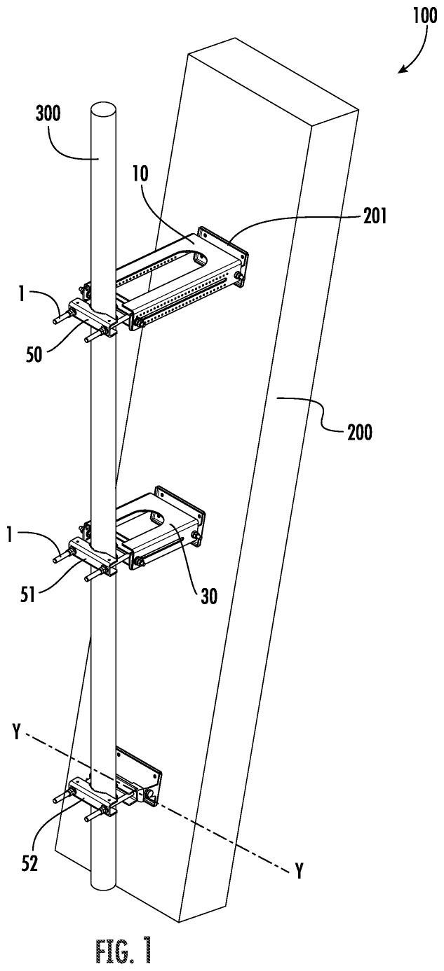

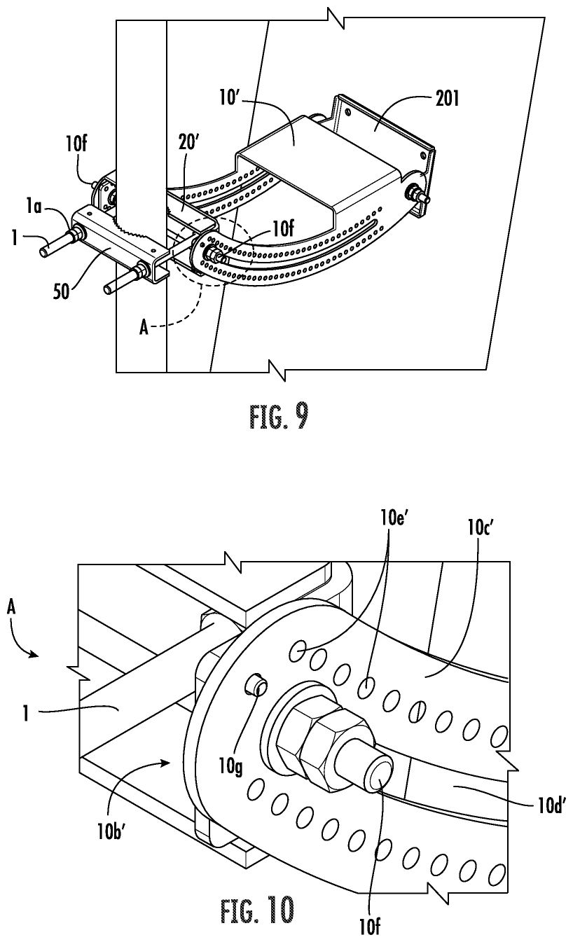

Embodiments of the disclosure are described in the following paragraphs with reference to FIGS. 1 to 21. In FIGS. 1 to 21, the same element or elements which have same functions are indicated by the same reference signs.

FIG. 1 is a perspective view of an exemplary mounting assembly 100 that has been utilized for mounting a base station antenna 200 to a support structure 300. The support structure 300 may be defined as a pole or any similar vertical structure rigidly fixed to a surface. The mounting assembly 100 is connected to a rear surface of the antenna 200. The rear surface of the antenna 200 is defined as a surface facing the support structure 300. The mounting assembly 100 may be mounted at any portion of the rear surface, depending on shape and size of the antenna 200. In an exemplary embodiment, the mounting assembly 100 is mounted at a top portion of the rear surface of the antenna 200. The mounting assembly 100 is removably connected to the antenna 200. The antenna 200 connected to the support structure 300 may require more than one mounting assembly 100, depending on size of the antenna 200.

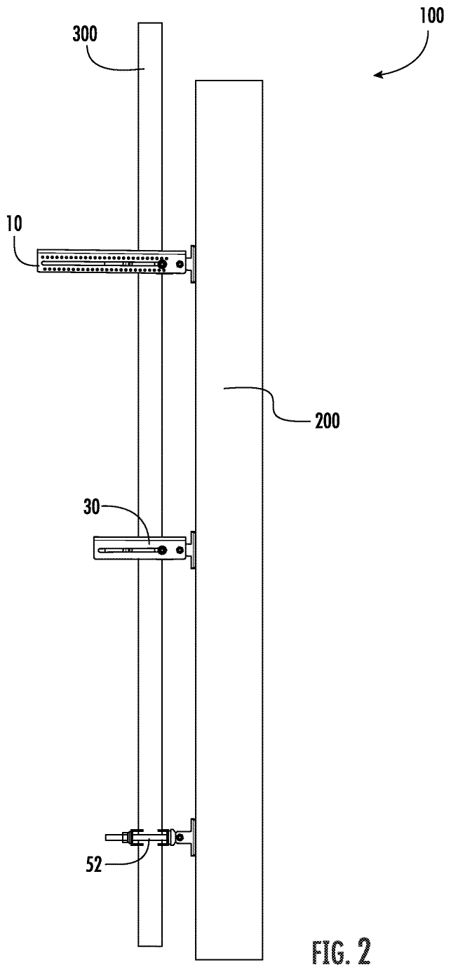

The mounting assembly 100 is configured to mount the antenna 200 on a support structure 300. In an embodiment, the support structure 300 is a pole, as shown in FIGS. 1, 2, 7, 8, 15 and 16, but is not limited to the same. The mounting assembly 100 is also configured to adjust the tilt angle of the antenna 200 to a predefined tilt angle. The tilt angle is defined as an angle made by the antenna 200 relative to a vertical axis of the support structure 300. In an exemplary embodiment, the mounting assembly 100 is configured to adjust the tilt angle of the antenna 200 from a zero-tilt angle or minimum tilt angle, as shown in FIGS. 2, 8 and 16 to a maximum tilt angle, as shown in FIGS. 1, 7 and 15. The adjustment of the tilt angle of the antenna 200 is required to vary the coverage of radio frequencies transmitted by the antenna 200. The zero-tilt angle position of the antenna 200 may also be defined as a minimum tilt angle position or upright position of the antenna 200.

The mounting assembly 100 includes a first bracket 10 and a second bracket 20. The first bracket 10 is removably connected to the rear surface of the antenna 200 by fasteners. In an exemplary embodiment, the antenna 200 comprises a top mounting plate 201 connected to the rear surface of the antenna 200. The first bracket 10 is defined having a first end 10a and a second end 10b. The first bracket 10 is removably connected to the top mounting plate 201 at the first end 10a. The first bracket 10 is connected to the top mounting plate 201 by the fasteners. In an exemplary embodiment, the first bracket 10 is pivotably connected to the top mounting plate 201 or the antenna 200 by the fasteners. The fasteners are defined as bolts having a head portion and a shaft portion. The length of the fasteners may vary depending on distance between two components of the mounting assembly. The shaft portion is defined with a plurality of threads configured to engage with a plurality of inner threads formed on a nut, preferably a lock nut.

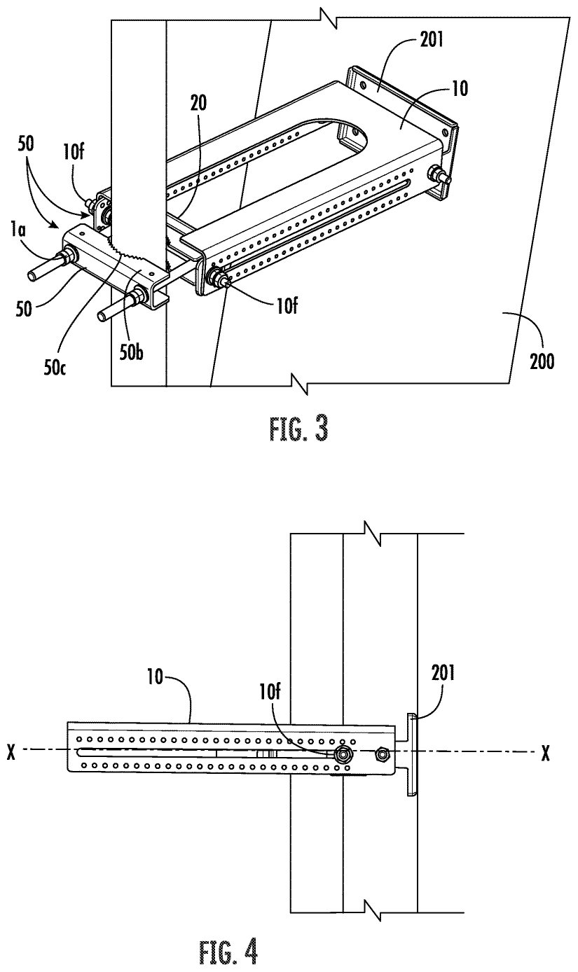

The first bracket 10 is connected to the second bracket 20 at the second end 10b. The first bracket 10 is configured to adjust the tilt angle of the antenna 200. The second bracket 20 is connected to one gripping clamp of a pair of gripping clamps 50. The one gripping clamp of the pair of gripping clamps 50 is then mounted to the support structure 300 by a plurality of long bolts 1. Each gripping clamp of the pair of gripping clamps 50 comprises a first plate 50a and two side plates 50b extending perpendicularly from longitudinal opposite edges of the first plate 50a. Each gripping clamp is defined having a plurality of serrations 50c formed at a center portion of each of the side plate of the two side plates 50b. The plurality of serrations 50c is configured to provide grip to the pair of gripping clamps 50 for mounting the gripping clamps 50 on the support structure 300. As shown in FIG. 3, the plurality of serrations 50c formed on a curved portion of the side plates 50b in order to provide firm grip to the gripping clamp, during mounting of the antenna 200 to the cylindrical shaped support structure 300. The side plates 50b may have different shaped profiles depending upon an outer profile of the support structure 300, for instance-if the support structure 300 has a polygonal shaped cross-section, then the side plates of the gripping clamp are formed with polygonal shaped portions at the center of the side plates. The first plate 50a of each gripping clamp of the pair of gripping clamps 50 is provided with a plurality of holes to receive long bolts 1 to connect gripping clamp with the support structure 300. Each long bolt of the plurality of long bolts 1 is locked by a corresponding nut la to secure the gripping clamp with the support structure 300. Although the exemplary configurations of the mounting assembly, as disclosed and shown in the present disclosure, describe long bolts 1 and nuts 1a for mounting the gripping clamp on the support structure 300, any other suitable fastening means may also be utilized to mount the gripping clamp on the support structure 300.

The mounting assembly further includes an intermediate bracket 30 to provide support to the antenna 200 having larger length. The intermediate bracket 30 is connected to an intermediate portion of the rear surface of the antenna 200. Similar to the first bracket 10, the intermediate bracket 30 is connected to an intermediate mounting plate 202 of the antenna 200. The intermediate mounting plate 202 is fixed to the intermediate portion of the rear surface of the antenna 200. The assembly 100 comprises a pair of intermediate gripping clamps 51 and a pair of lower gripping clamps 52. The intermediate bracket 30 is connected to one intermediate gripping clamp of the pair of intermediate gripping clamps 51 through the second bracket 20. One gripping clamp of the pair of lower gripping clamps 52 is pivotably connected to the rear surface of the antenna 200. In an exemplary embodiment, the one gripping clamp of the pair of lower gripping clamps 52 is pivotably connected to a lower mounting plate 203 of the antenna 200 by means of fasteners. The antenna 200 is configured to pivot about an axis Y-Y passing through the fasteners connecting the one lower gripping clamp of the pair of lower gripping clamps 52 with the antenna 200, as shown in FIG. 1.

The number of pair of gripping claims to be utilized for mounting the antenna 200 on the support structure 300 may vary and the number depends on the shape and size of the antenna 200, and in particular the length of the antenna 200. The pair of intermediate gripping clamps 51 and the intermediate bracket 30 may be omitted, when length of the antenna 200 is less and therefore additional support to the antenna 200 not required or desired. The construction features of the pair of intermediate gripping clamps 51 and the lower gripping clamps 52 are similar to the construction of the pair of gripping clamps 50, as described in previous paragraphs.

Referring to FIGS. 1-6, the mounting assembly 100 and its components in accordance with an exemplary embodiment is depicted. Referring to FIG. 1 and FIG. 2, the maximum tilt position and the zero tilt position of the antenna 200 are depicted utilizing the components of the assembly, in accordance with the embodiment.

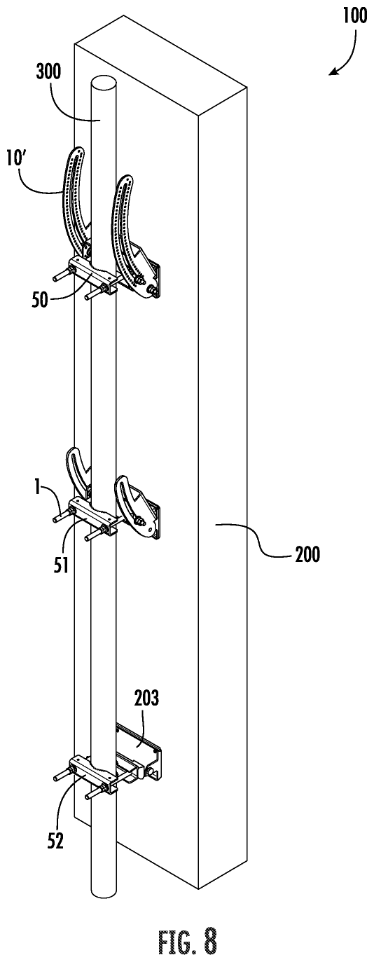

Referring to FIGS. 7-14, the mounting assembly 100 and its components in accordance with other exemplary embodiment are depicted. Referring to FIG. 7 and FIG. 8, the maximum tilt position and the zero tilt position of the antenna 200 are depicted utilizing the components of the assembly in accordance with the embodiment.

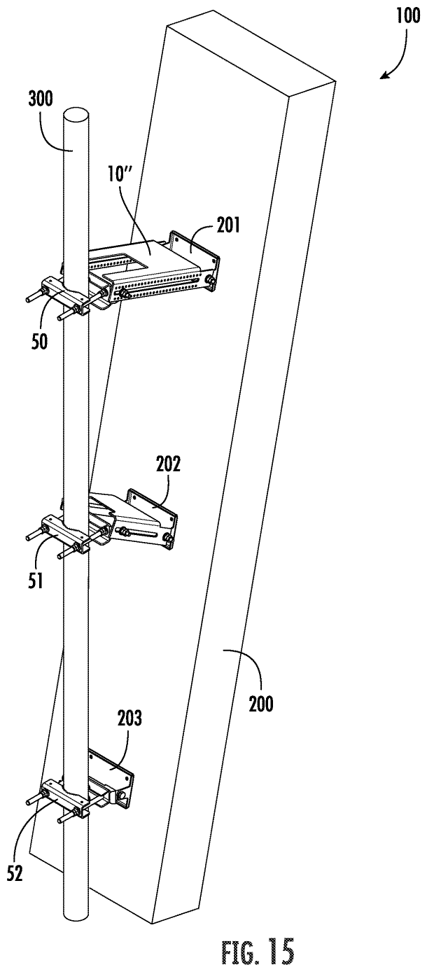

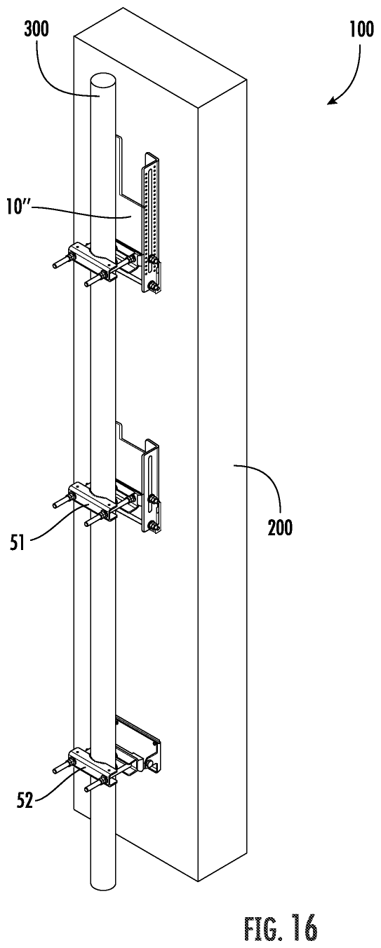

Referring to FIGS. 15-21, the mounting assembly and its components in accordance with another embodiment is depicted. The respective FIGS. depict different views of the mounting assembly 100 and separate views of the components of the mounting assembly 100, in accordance with the embodiment. Referring to FIG. 15 and FIG. 16, the maximum tilt position and the zero tilt position of the antenna 200 are depicted, in accordance with the embodiment. Further, a person skilled in the art may modify the construction of the components in view of the provided description of the three preferred embodiments of the mounting assembly 100 and therefore, such modifications should and are intended to be comprehended within the meaning and range of equivalents of the disclosed embodiments.

The mounting assembly 100 in accordance with the respective preferred embodiments are explained below in detail.

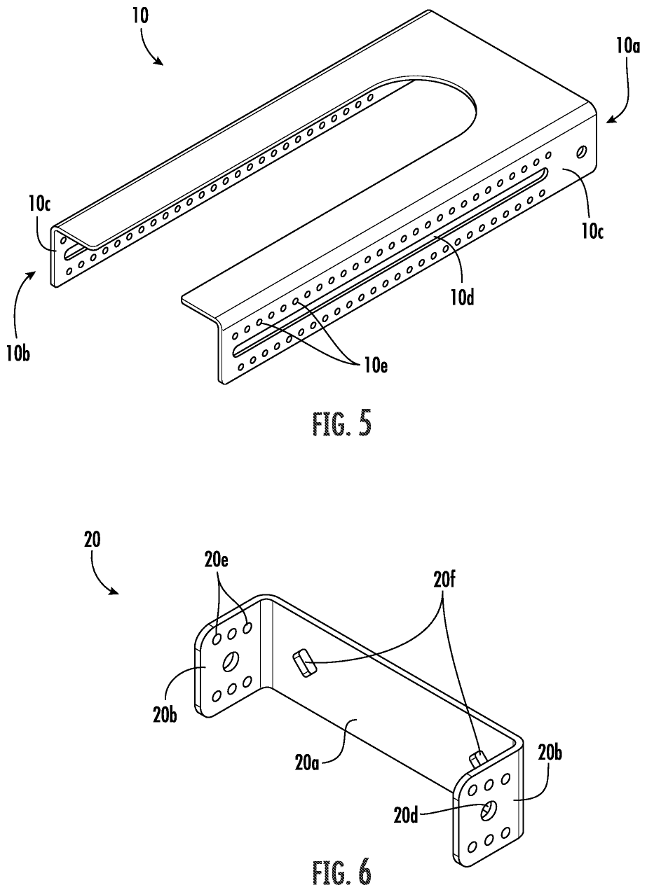

In the embodiment depicted in FIGS. 1-6, the mounting assembly 100 comprises the first bracket 10 and the second bracket 20. The first bracket 10 is adapted to be coupled to the rear surface of the antenna 200. The first bracket 10 comprises two side walls 10c, such that each side wall of the two side walls 10c is defined having a longitudinal slot 10d and a plurality of first indexing holes 10e, as shown in FIG. 5. The plurality of first indexing holes 10e in the first bracket 10 are defined circumscribing the longitudinal slot 10d defined in each side wall of the two side walls 10c of the first bracket 10. The two side walls 10c extend from each edge of two longitudinal edges of the first bracket 10. Each side wall of the two side walls 10c is defined having a rectangular structure, but not limited to the same. The longitudinal slot 10d is configured to extend from one end of the side wall to another end of the side wall and said longitudinal slot 10d is preferably defined at a center portion of the side wall, but not limited to the same. The longitudinal slot 10d is defined such that the longitudinal slot 10d extends in a direction parallel to the longitudinal edge of the first bracket 10. The longitudinal slot 10d is configured to facilitate linear movement of the first bracket 10 with respect to the second bracket 20 or the antenna 200 and thereby facilitate adjustment of the tilt angle or tilt position of the antenna 200 to a predefined tilt position.

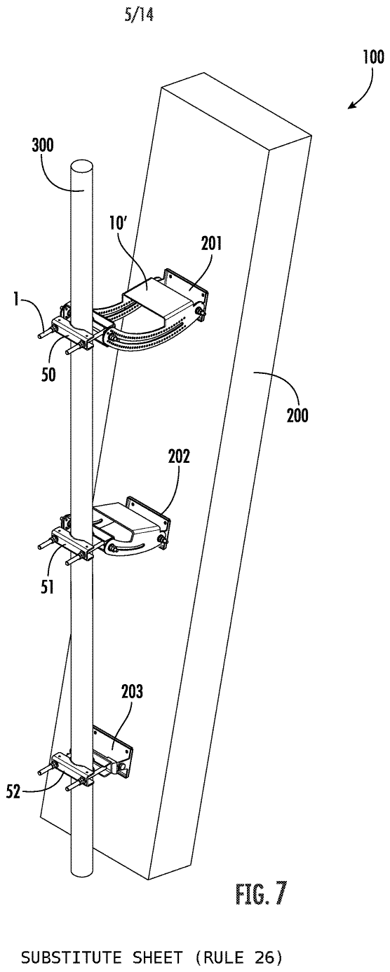

Referring to FIG. 6, the second bracket 20 comprises a center hole 20d and a plurality of second indexing holes 20e. The center hole 20d is configured to align with the longitudinal slot 10d of the first bracket 10 and at least two second indexing holes 20e of the plurality of second indexing holes 20e are aligned with corresponding first indexing holes of the plurality of first indexing holes 10e of the first bracket 10, to facilitate mounting of the antenna 200 with the support structure 300. The second bracket 20 further includes two lateral flanges 20b extending from a base plate 20a, such that each lateral flange of the two lateral flanges 20b is defined having the center hole 20d and the plurality of second indexing holes 20e.

The first bracket 10 is defined as having the first end 10a and the second end 10b, such that the first end 10a is connected to the rear surface of the antenna 200, and in some embodiments to the top mounting plate 201 attached to the rear surface of the antenna 200, as shown in FIG. 3. The second end 10b of the first bracket 10 is connected to the second bracket 20, such that the first end 10a and the second end 10b are aligned along a mounting axis X-X of the antenna 200, as shown in FIG. 4. The first end 10a of the first bracket 10 is connected to the antenna 200 by means of fasteners and prevent movement of the first bracket 10 with respect to the antenna 200. The second end 10b of the first bracket 10 is movably connected to the second bracket 20 by a pair of fasteners 10f, such that at least one fastener is allowed to pass through the longitudinal slot 10d defined in one side wall of the first bracket 10 and the center hole 20d defined in one flange of the second bracket 20. Another fastener is allowed to pass through the longitudinal slot 10d defined in another side wall of the first bracket 10 and the center hole 20d defined in another flange of the second bracket 20. A lock nut is then received on a threaded portion of each fastener of the pair of fasteners 10f. In an exemplary embodiment, the at least one locking pin 10g is adapted to be received in the at least one first indexing hole 10e of the first bracket 10 aligned with the at least one second indexing hole 20e of the second bracket 20, to secure the antenna 200 at the predefined tilt angle.

According to this embodiment, the second bracket 20 is placed on one gripping clamp of the pair of gripping clamps 50. The base plate 20a of the second bracket 20 is defined having at least two rectangular holes 20f, as shown in FIG. 6. Alternatively, the shape of the holes may vary, for example the shape may be circular, polygonal and likewise. The two rectangular holes 20f are adapted to receive the long bolts 1 to connect the second bracket 20 with the one gripping clamp of the pair of gripping clamps 50. The long bolts 1 thereby connect the one gripping clamp with another gripping clamp disposed on opposite of the support structure 300. The long bolts 1 are utilized to mount the pair of gripping clamps 50 on the support structure 300 and also to connect the second bracket 20 with the one gripping clamp of the pair of gripping clamps 50. The long bolts 1 are then locked by lock nuts la received on the threaded portion of the long bolts 1. In an exemplary embodiment, the second bracket 20 may integrally be formed with the one gripping clamp of the pair of gripping clamps 50 and thereby the second bracket 20 is configured to grip the support structure 300 for mounting the antenna 200.

A method for adjusting tilt of the antenna 200 comprises the steps of: removing the locking pins 10g received in the first indexing holes 10e of the first bracket 10 and second indexing holes 20e of the second bracket 20, from both the flanges of the second bracket 20. The next step is of loosening the pair of lock nuts engaged with the pair of fasteners 10f configured to connect the first bracket 10 with the second bracket 20. The third step is to pull or push the antenna 200 from the top portion of the antenna 200 to a predefined tilt angle, such that the antenna 200 possesses a pivotal movement about the axis Y-Y passing through the fasteners connecting the one lower gripping clamp of the pair of lower gripping clamps 52 with the antenna 200. Once the antenna 200 is positioned at the predefined tilt angle, tighten the pair lock nuts engaged with the pair of fasteners 10f and insert the locking pin 10g through the aligned first indexing holes 10e of the first bracket 10 and second indexing holes 20e of the second bracket 20 to lock the antenna 200 at the predefined tilt angle or tilt position. The method steps disclosed above is for the mounting assembly in which no intermediate bracket 30 is provided to support the antenna 200. Also, said method steps are applicable to all three preferred embodiments of the present disclosure.

In other embodiments, the structure of a first bracket 10′ and the second bracket 20′ differs with respect to the first bracket 10 and the second bracket 20 of the above embodiment. The first bracket 10 disclosed above is configured to extend beyond the support structure 300 when the antenna 200 is mounted on the support structure 300 at zero-tilt position, as shown in FIG. 4. According to other embodiments illustrated in FIGS. 7-14, the first bracket 10′ does not extend beyond the support structure 300, when the antenna 200 is in the zero-tilt position or minimum tilt position.

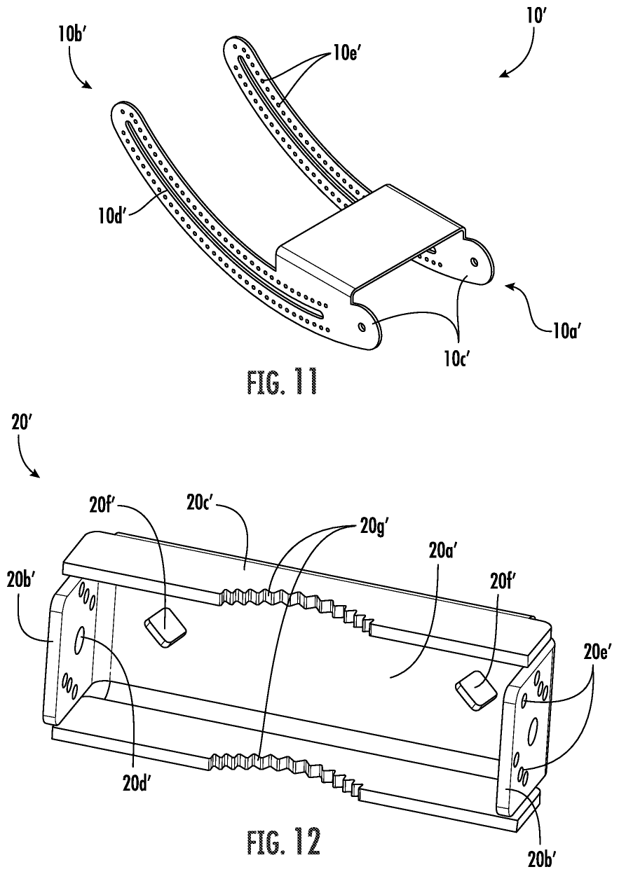

In this embodiment, the mounting assembly 100 comprises the first bracket 10′ and the second bracket 20′. The first bracket 10′ is adapted to be coupled to the rear surface of the antenna 200. The first bracket 10′ comprises two side walls 10c', such that each side wall of the two side walls 10c′ is defined having a longitudinal slot 10d′ in shape of an arc and a plurality of first indexing holes 10e′, as shown in FIG. 10 and FIG. 11. The plurality of first indexing holes 10e′ in the first bracket 10′ are defined circumscribing the longitudinal slot 10d′ defined in each side wall of the two side walls 10c′ of the first bracket 10′. The two side walls 10c′ extend from each edge of two longitudinal edges of the first bracket 10′. Each side wall of the two side walls 10c′ of the first bracket 10′ is defined in shape of an arc that is complimentary to the arc shape of the longitudinal slot 10d′ defined in each side wall. The shape of the two side walls 10c′ may be defined as rectangular, within the which the longitudinal slot 10d′ is defined having an arc shaped profile. The longitudinal slot 10d′ is configured to extend from one end of the side wall to another end of the side wall and said longitudinal slot 10d′ is preferably defined at center portion of the side wall, but not limited to the same. The longitudinal slot 10d′ is defined such that the longitudinal slot 10d′ extends in a direction parallel to the longitudinal edge of the first bracket 10′. The longitudinal slot 10d′ is configured to facilitate linear movement of the first bracket 10′ with respect to the second bracket 20′ or the antenna 200 and thereby facilitate adjustment in tilt angle or tilt position of the antenna 200 to a predefined tilt position.

Referring to FIG. 12, the second bracket 20′ comprises a center hole 20d′ and the plurality of second indexing holes 20e'. The center hole 20d′ is configured to align with the longitudinal slot 10d′ of the first bracket 10′ and at least two second indexing holes 20e′ of the plurality of second indexing holes 20e′ are aligned with corresponding first indexing holes 10e′ of the plurality of first indexing holes 10e′ of the first bracket 10′, to facilitate mounting of the antenna 200 with the support structure 300. The second bracket 20′ includes two lateral flanges 20b′ extending integrally from the base plate 20a′ of the second bracket 20′, such that each lateral flange of the two lateral flanges 20b′ is defined having the center hole 20d′ and the plurality of second indexing holes 20e′. The second bracket 20′ further includes two longitudinal flanges 20c′ extending integrally from the base plate 20a′, each longitudinal flange of the two longitudinal flanges 20c′ is defined having serrations 20g′ to grip the second bracket 20′ with the support structure 300.

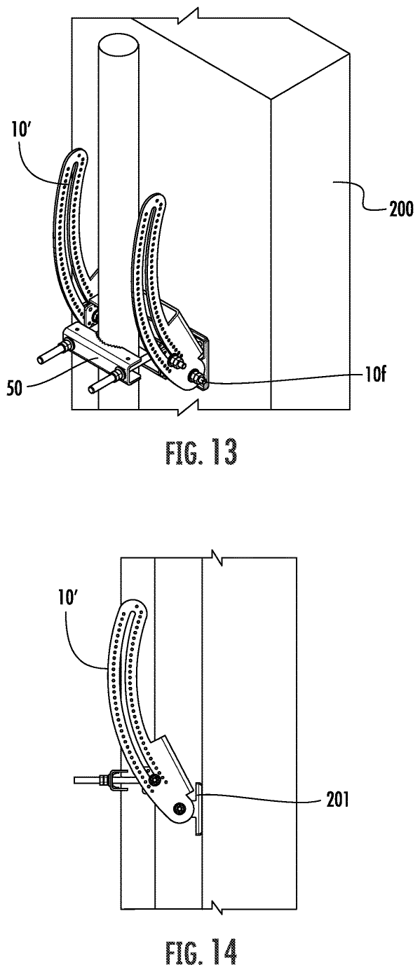

The first bracket 10′ comprising the first end 10a′ and the second end 10b′, such that the first end 10a′ connected to the antenna 200 is positioned below the second end 10b′ connected to the second bracket 20′, as shown in FIG. 13 and FIG. 14, when the antenna 200 is in the zero-tilt position or minimum tilt position. The first end 10a′ of the first bracket 10′ is pivotably connected to the antenna 200. In some embodiments, the first end 10a′ of the first bracket 10′ is pivotably connected to the top mounting plate 201 of the antenna 200. The second end 10b′ of the first bracket 10′ is movably connected to the second bracket 20′ by the pair of fasteners 10f, such that one fastener is allowed to pass through the longitudinal slot 10d′ defined in one side wall of the first bracket 10′ and the center hole 20d′ defined in one flange of the second bracket 20′. Another fastener is allowed to pass through the longitudinal slot 10d′ defined in another side wall of the first bracket 10′ and the center hole 20d′ defined in another flange of the second bracket 20′. The lock nut is then received on a threaded portion of each fastener of the pair of fasteners 10f. The at least one locking pin 10g is adapted to be received in the first indexing holes 10e′ of the first bracket 10′ and the second indexing holes 20e′ of the second bracket 20′, to secure the antenna 200 at the predefined tilt angle.

The second bracket 20′ is designed in such a way that the second bracket 20′ fulfils the functionality of one gripping clamp of the pair of gripping clamps 50′. The plurality of serrations 20g′ provided in each longitudinal flange of the two longitudinal flanges 20c′ is configured to grip the second bracket 20′ with the support structure 300 or pole. According to the embodiment II, only one gripping clamp is required to grip the support structure 300 from one side and from other side the second bracket 20′ is configured to grip the support structure 300. The second bracket 20′ is defined having two rectangular holes 20f′ on the base plate 20a′ of the second bracket 20′, as shown in FIG. 12. The two rectangular holes 20f′ are adapted to receive the long bolts 1 to connect the second bracket 20′ with the one gripping clamp. The long bolts 1 are utilized to mount the one gripping clamp and the second bracket 20′ with the support structure 300. The long bolts 1 are then locked by lock nuts la received on the threaded portion of the long bolts 1. Alternatively, other locking means may be utilized to lock the lock nuts la, for example-a dowel pin and likewise.

Referring now to FIGS. 15-21, in other embodiments, the first bracket 10″ is defined having a compact structure such that the first bracket 10″ occupies less packaging space and thereby resulting easy and cost-effective transportation of the first bracket 10″ from the manufacturing unit to the mounting site. Also, the first bracket 10″ of such embodiments does not extend beside the support structure 300, when the antenna 200 is mounted on the support structure 300 at zero-tilt position.

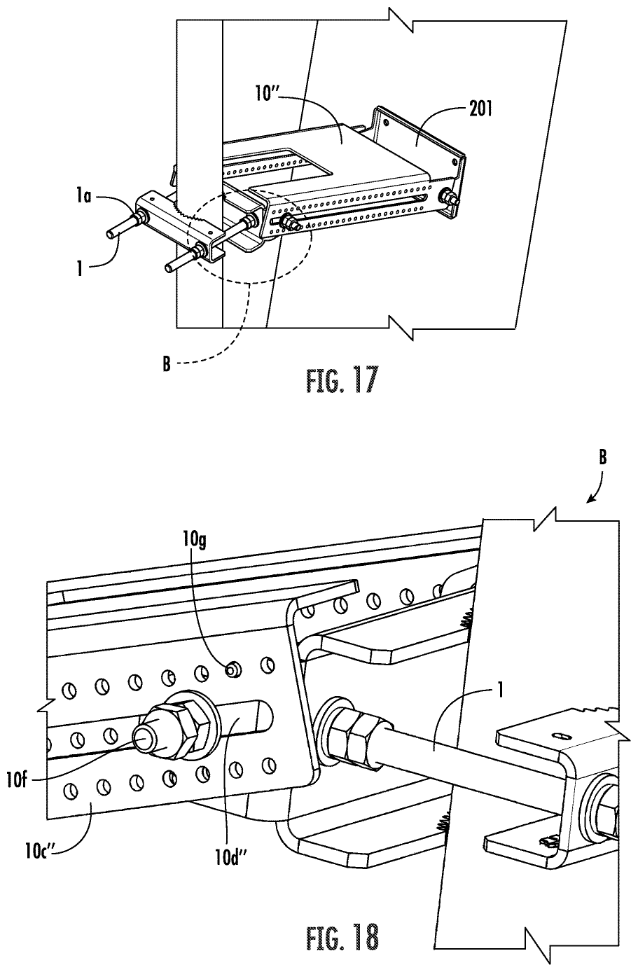

The mounting assembly comprises the first bracket 10″ and the second bracket 20″. The first bracket 10″ is adapted to be coupled to the rear surface of the antenna 200. The first bracket 10″ comprises two side walls 10c″, such that each side wall of the two side walls 10c″ is defined having the longitudinal slot 10d″ and the plurality of first indexing holes 10e″, as shown in FIGS. 17-19. The plurality of first indexing holes 10e″ in the first bracket 10″ are defined circumscribing the longitudinal slot 10d″ defined in each side wall of the two side walls 10c″ of the first bracket 10″. The two side walls 10c″ extend from each edge of two longitudinal edges of the first bracket 10″. The longitudinal slot 10d″ is configured to extend from one end of the side wall to another end of the side wall and said longitudinal slot 10d″ is preferably defined at center portion of the side wall, but not limited to the same. The longitudinal slot 10d″ is defined such that the longitudinal slot 10d″ extends in a direction parallel to the longitudinal edge of the first bracket 10″. The longitudinal slot 10d″ is configured to facilitate linear movement of the first bracket 10″ with respect to the second bracket 20″ or the antenna 200 and thereby facilitate adjustment in tilt angle or tilt position of the antenna 200 to a predefined tilt position.

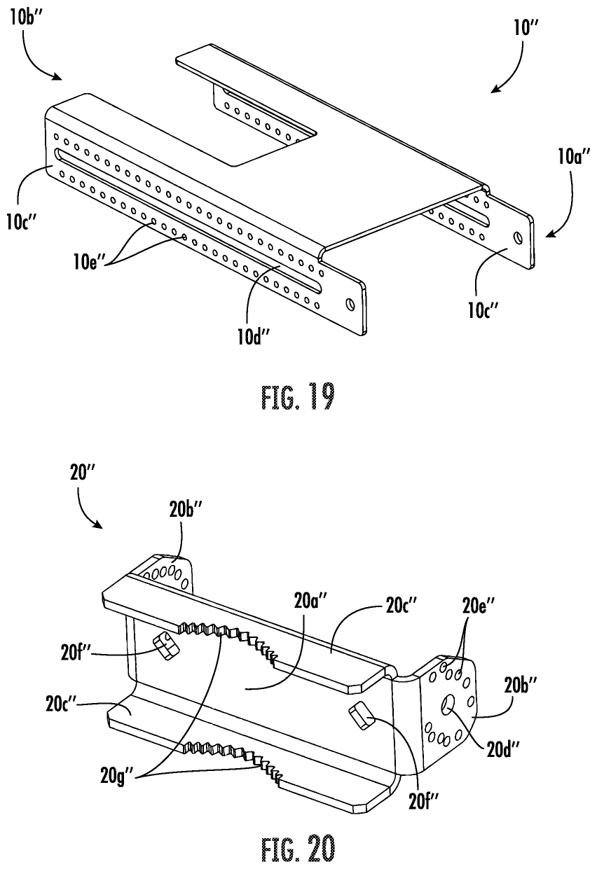

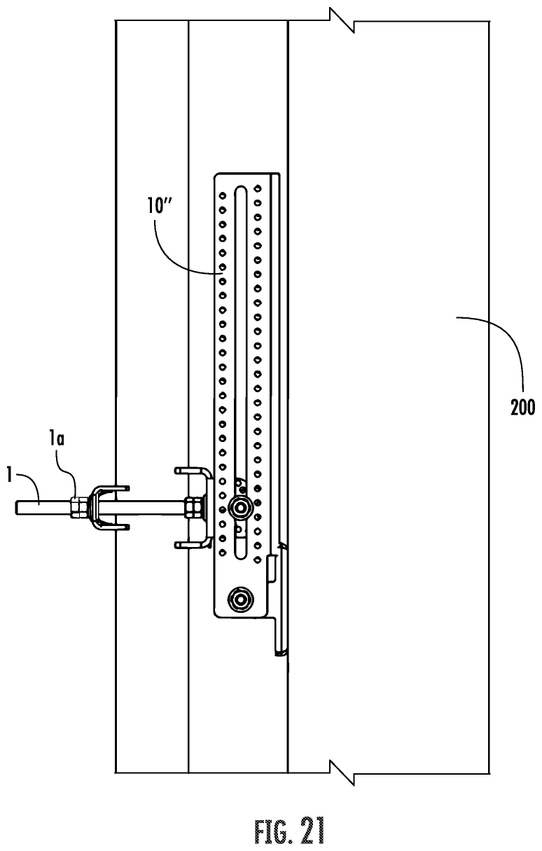

Referring to FIG. 20, the second bracket 20″ comprises the center hole 20d″ and the plurality of second indexing holes 20e″. The second bracket 20″ is configured to grip the support structure 300 for mounting the antenna 200 and the first bracket 10″ is adjustably connected to the second bracket 20″ to adjust the tilt angle of the antenna 200. The center hole 20d″ of the second bracket 20″ is configured to align with the longitudinal slot 10d″ of the first bracket 10″ and at least two second indexing holes 20e″ of the plurality of second indexing holes 20e″ are configured to align with corresponding first indexing holes 10e″ of the plurality of first indexing holes 10e″ of the first bracket 10″, to facilitate mounting of the antenna 200 with the support structure 300. The second bracket 20″ includes two lateral flanges 20b″ extending integrally from the base plate 20a″ of the second bracket 20″, such that each lateral flange of the two lateral flanges 20b″ is defined having the center hole 20d″ and the plurality of second indexing holes 20e″. The second bracket 20″ further includes two longitudinal flanges 20c″ extending integrally from the base plate 20a″, each longitudinal flange of the two longitudinal flanges 20c″ is defined having serrations 20g″ to grip the second bracket 20″ with the support structure 300. The two lateral flanges 20b″ extend from the base plate 20a″ of the second bracket 20″ in a direction opposite to a direction of the two longitudinal flanges 20c″, as shown in FIG. 20.

The first bracket 10″ comprises a first end 10a″ and the second end 10b″, such that the first end 10a″ connected to the antenna 200 is positioned below the second end 10b″ connected to the second bracket 20″, as shown in FIG. 16 and FIG. 21. The first end 10a″ of the first bracket 10″ is pivotably connected to the antenna 200. In an embodiment, the first end 10a″ of the first bracket 10″ is pivotably connected to the top mounting plate 201 of the antenna 200. The second end 10b″ of the first bracket 10″ is movably connected to the second bracket 20″ by the pair of fasteners 10f, such that one fastener is allowed to pass through the longitudinal slot 10d″ defined in one side wall of the first bracket 10″ and the center hole 20d″ defined in one flange of the second bracket 20″. Another fastener is allowed to pass through the longitudinal slot 10d″ defined in another side wall of the first bracket 10″ and the center hole 20d″ defined in another flange of the second bracket 20″. The lock nut is then received on a threaded portion of each fastener of the pair of fasteners 10f. The at least one locking pin 10g is adapted to be received in the first indexing holes 10e of the first bracket 10″ and the second indexing holes 20e″ of the second bracket 20″, to secure the antenna 200 at the predefined tilt angle.

The second bracket 20″ is designed in such a way that the second bracket 20″ fulfils the functionality of one gripping clamp of the pair of gripping clamps 50″. The plurality of serrations 20g″ provided in each longitudinal flange of the two longitudinal flanges 20c″ is configured to grip the second bracket 20″ with the support structure 300 or pole. According to this embodiment, only one gripping clamp is required to grip the support structure 300 from one side and from other side the second bracket 20″ is configured to grip the support structure 300. The second bracket 20″ is defined having two rectangular holes 20f″ on the base plate 20a″ of the second bracket 20″, as shown in FIG. 20. The two rectangular holes 20f″ are adapted to receive the long bolts 1 to connect the second bracket 20″ with the one gripping clamp. The long bolts 1 are utilized to mount the one gripping clamp and the second bracket 20 with the support structure 300. The long bolts 1 are then locked by lock nuts 1a received on the threaded portion of the long bolts 1.

Referring to FIG. 16 and FIG. 21, the antenna 200 mounted to the support member at zero-tilt or minimum tilt angle is depicted. In zero-tilt position of the antenna 200, the first bracket 10″ does not extend beyond the support structure 300.

In an embodiment, the mounting assembly for the antenna is configured to provide easy and quick assembling of the antenna on the support structure.

In an embodiment, the mounting assembly for the antenna is having longer life due to lesser number of pivotal joints to facilitate adjusting of tilt angle of the antenna.

The various embodiments of the present disclosure have been described above with reference to the accompanying drawings. The present disclosure is not limited to the illustrated embodiments; rather, these embodiments are intended to fully and completely disclose the subject matter of the disclosure to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the figures is turned over, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Herein, the terms “attached”, “connected”, “interconnected”, “contacting”, “mounted”, “coupled” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

1. A mounting assembly for an antenna, the mounting assembly comprising:
a first bracket adapted to be coupled to a rear surface of the antenna;
a second bracket connected to a gripping clamp, wherein the first bracket is adjustably connected to the second bracket to adjust a tilt angle of the antenna;
wherein the first bracket comprises two side walls, wherein each side wall of the two side walls includes a longitudinal slot and a plurality of first indexing holes; and
wherein the second bracket comprises a center hole and a plurality of second indexing holes, wherein the center hole is configured to align with the longitudinal slot of the first bracket and at least two second indexing holes of the plurality of second indexing holes are aligned with corresponding first indexing holes of the plurality of first indexing holes of the first bracket, to facilitate mounting of the antenna.

2. The mounting assembly as claimed in claim 1, wherein the second bracket is integrally formed with the gripping clamp.

3. The mounting assembly as claimed in claim 1 wherein the plurality of first indexing holes in the first bracket is defined circumscribing the longitudinal slot present in each side wall of the two side walls of the first bracket.

4. The mounting assembly as claimed in claim 1, wherein the second bracket comprises two lateral flanges extending from a base plate, wherein each lateral flange of the two lateral flanges is defined having the center hole and the plurality of second indexing holes.

5. The mounting assembly as claimed in claim 4, comprising a pair of fasteners, wherein
one fastener is allowed to pass through the longitudinal slot defined in one side wall of the first bracket and the center hole defined in one flange of the second bracket, and
another fastener is allowed to pass through the longitudinal slot defined in another side wall of the first bracket and the center hole defined in another flange of the second bracket.

6. (canceled)

7. The mounting assembly as claimed in claim 1, comprising at least one locking pin adapted to be received in the first indexing holes of the first bracket and the second indexing holes of the second bracket, to secure the antenna at the tilt angle.

8. The mounting assembly as claimed in claim 2, wherein the second bracket is configured to grip a support structure for mounting the antenna.

9. The mounting assembly as claimed in claim 1, wherein the first bracket comprises a first end and a second end, wherein
the first end connected to the antenna is positioned below the second end connected to the second bracket.

10. A mounting assembly for an antenna, the mounting assembly comprising:
a first bracket adapted to be coupled to a rear surface of the antenna;
a second bracket configured to grip a support structure for mounting the antenna, wherein the first bracket is adjustably connected to the second bracket to adjust a tilt angle of the antenna;
the first bracket comprises two side walls, wherein each side wall of the two side walls includes an arcuate longitudinal slot and a plurality of first indexing holes; and
the second bracket comprises a center hole and a plurality of second indexing holes, wherein the center hole is configured to align with the longitudinal slot of the first bracket and at least two second indexing holes of the plurality of second indexing holes are aligned with corresponding indexing holes of the plurality of first indexing holes of the first bracket, to facilitate mounting of the antenna.

11. The mounting assembly as claimed in claim 10, wherein the second bracket comprises two lateral flanges extending integrally from a base plate of the second bracket, wherein each lateral flange of the two lateral flanges is defined having the center hole and the plurality of second indexing holes.

12. The mounting assembly as claimed in claim 11, wherein the second bracket comprises two longitudinal flanges extending integrally from the base plate, each longitudinal flange of the two longitudinal flanges is defined having serrations to grip the second bracket with the support structure.

13. The mounting assembly as claimed in claim 10, wherein each side wall of the two side walls of the first bracket is defined in shape of an arc that is complimentary to the arc of the longitudinal slot defined in the side wall.

14. The mounting assembly as claimed in claim 10, wherein the first
bracket comprises a first end and a second end, wherein
the first end connected to the antenna is positioned below the second end connected to the second bracket.

15-20. (canceled)

21. A mounting assembly for an antenna, comprising:
a first bracket adapted to be coupled to a rear surface of the antenna;
a second bracket configured to grip a support structure for mounting the antenna, wherein the first bracket is adjustably connected to the second bracket to adjust a tilt angle of the antenna,
the first bracket comprises two side walls, each of the side walls including a longitudinal slot, wherein at least a portion of the longitudinal slot has an arcuate shape.

22. The mounting assembly as claimed in claim 21, wherein the first bracket comprises a plurality of indicia residing along each longitudinal slot of the first bracket.

23. The mounting assembly as claimed in claim 21, further comprising a fastener extending through each longitudinal slot and connects the first bracket to the second bracket.

24. The mounting assembly as claimed in claim 23, wherein each fastener is configured to slide within the respective longitudinal slot to adjust the tilt angle of the antenna.

25. The mounting assembly as claimed in claim 21, further comprising
a third bracket adapted to be coupled to a rear surface of the antenna;
a fourth bracket configured to grip the support structure for mounting the antenna, wherein the third bracket is pivotably connected to the fourth bracket,
wherein the third and fourth brackets reside below the first and second brackets.

26. The mounting assembly as claimed in claim 21, wherein the first bracket is generally parallel to a longitudinal axis of the support structure when in a retracted position and generally perpendicular to the longitudinal axis of the support structure when in an extended position.

27. The mounting assembly as claimed in claim 26, wherein, when in the retracted position, the portion of each longitudinal slot having the arcuate shape resides at a lower end of the longitudinal slot, thereby allowing the antenna to be positioned closer to the support structure.
